(19) United States
(12) Patent Application Publication
(10) Pub. No.: US 2022/0203163 A1
(43) Pub. Date: Jun. 30, 2022

(54) MARTIAL ARTS POLEARM POSTURE SENSING DEVICE AND POSTURE SENSING METHOD THEREOF

(71) Applicant: HUNG MING INFOIRMATION CO., LTD., TAICHUNG CITY (TW)

(72) Inventor: CHIA CHUN YEN, TAICHUNG CITY (TW)

(21) Appl. No.: 17/181,289

(22) Filed: Feb. 22, 2021

(30) Foreign Application Priority Data
Dec. 30, 2020 (TW) 109217374

(51) Int. Cl. A63B 24/00; A63B 69/00

(52) U.S. Cl. CPC A63B 24/0003; A63B 2244/10; A63B 2220/40; A63B 69/004

(57) ABSTRACT

The present invention relates to a martial arts polearm posture sensing device and the posture sensing method thereof, wherein two sensor units are installed on the polearm neck and the polearm end separately in order to collect sensor signals of the angular acceleration, acceleration or/and geomagnetic field intensity of the polearm neck and the polearm end respectively, and then output the sensor signals to the outside. The signals generated by these two sensor units are received by the computer equipment and converted by the computation and conversion modules, installed in the computer equipment, into signals of the motion posture at a specific time and the overall motion trajectory of the martial arts polearm for output thus to facilitate the analysis and intelligent comparison by the smart sports module. The present invention helps the trainees and the instructors to learn or teach the martial arts polearm postures and makes the exercise and training easier while discovering the most suitable techniques and moves of the martial arts polearm.

### BACKGROUND OF THE INVENTION

### 1. Fields of the Invention

The present invention relates to the domain of teaching and training martial arts sports, especially, the technical scope of sensing the martial arts polearm postures.

### 2. Descriptions of Related Art

Please refer to FIG. 1. The martial arts polearm 1 is one of Chinese ancient weapons and belongs to the long pole weapons with a sharp point. Due to the fact that the martial arts polearm 1 is an important weapon in ancient wars, its technology has been developed since early historical time and its techniques have been commonly imparted. So far, weapons used in the world's martial arts have four major categories, knife, polearm, sword, and club, wherein martial arts polearm 1 is dubbed as “the king of all weapons”; one famous polearm fighting techniques passed down for generations is the technique of “Yang Family Polearm”; the martial arts sports of polearms are part of the Wushu Competition at the Asian Gaines.

Generally, the martial arts polearm 1 comprises a polearm head 11, a polearm neck 2, a polearm shaft 13, and a polearm end 14. The common method to practice techniques and moves of the martial arts polearm is to hire professional trainers who teach the correct postures and prevent sports accidents. Furthermore, observations and reminders from the trainer can correct the wrong postures while practicing the martial arts polearm techniques and moves. However, the tuition will be usually more expensive for a one-to-one teaching approach that is not affordable for the general public for trainings stretching for a long period of time. If a one-to-many teaching approach is chosen, the learning effect can be quite limited.

There are also methods to pre-record the practice for the individual to view the postures and moves of oneself performing the martial arts polearms during the teaching and training program. However, the effect of this type of methods can be limited, resulted from the blind spots in the recording process due to the fixed-point setting of the video recorder. Therefore, there is a need to improve the current models of training, practicing or teaching the martial arts polearms.

### SUMMARY OF THE INVENTION

Therefore, in view of the problems that exist in the training or teaching methods of the martial arts polearms, the inventor of the present invention investigated the aforementioned deficiency, searched intensively for the solutions thereof, and invented the martial arts polearm posture sensing device and the posture sensing method thereof. When the polearm end moves a little, the polearm neck will move noticeably according to the principle of lever. Therefore, a sensor unit is installed separately on the polearm end and the polearm neck; information of the sensor data detected by these two sensor units, collected and analyzed through the smart phone APP, tablet PC, or general computer, provides the user with instant feedback. Relevant data are transmitted back to the AI data center (that is, the cloud server) for storage and is not transmitted back to the user's mobile phone along with other social network information of practitioners, or courses of martial arts polearms in order to increase user loyalty. The main objectives of the present invention are to help the trainees to practice and find the most suitable techniques and moves of martial arts polearm, assist the trainers in teaching the martial arts polearms, promote the martial arts polearm competition, record the martial arts competition data of each contest, and help relevant associations to promote martial arts polearm sports.

To achieve the aforementioned effects and objectives, the present invention applies the following technical approach. The martial arts polearm posture sensing device comprises a first sensor installed on the polearm neck, which comprises a first communication module, a first control unit, a first posture sensing unit, and a battery unit, wherein the first posture sensing unit outputs signals of the angular acceleration, acceleration, or/and the geomagnetic field intensity of the change of the polearm neck's position; a second sensor installed on the polearm end which comprises a second communication module, a second control unit, a second posture sensing unit, and a battery unit, wherein the second posture sensing unit outputs signals of the angular acceleration, acceleration, or/and the geomagnetic field intensity of the change of the polearm end's position; a computer equipment, coupled to the first sensor and the second sensor respectively, which further comprises a central processing unit and an output unit, wherein the central processing unit receives sensor signals from the first sensor and the second sensor to compute and convert the data into the motion posture at a specific time or/and the overall motion trajectory of the martial arts polearm to be output to the output unit;

wherein the computer equipment is electrically connected via wire or coupled via wireless to the first sensor and the second sensor respectively;

wherein the first posture sensing unit comprises a first gyroscope, a first accelerometer or/and a first geomagnetic transducer in triaxial form; the second posture sensing unit comprises a second gyroscope, a second accelerometer or/and a second geomagnetic transducer in triaxial form;

wherein the central processing unit further comprises a first computation and conversion unit; the first computation and conversion unit converts the signals from the first sensor and the second sensor into a first posture angle signal of the position of the polearm neck and a second posture angle signal of the position of the polearm end respectively;

wherein the central processing unit further comprises a second computation and conversion unit; the second computation and conversion unit converts the first posture angle signal and the second posture angle signal into parameters of the position coordinate (X₁,Y₁,Z₁) of the position of the polearm neck and the position coordinate (X₂,Y₂,Z₂) of the position of the polearm end respectively;

wherein the first sensor and the second sensor also are installed with a first microphone and a second microphone respectively in order to synchronously collect sound generated from motion of the martial marts polearm to be output to the output unit in audiovisual form.

The martial arts polearm posture sensing device further comprises a cloud server that is connected with the computer equipment through communication connection using internet and stores the motion data of the martial arts polearm, so that the cloud server can serve as an AI data center.

The martial arts polearm posture sensing method of the present invention comprises the steps of: a polearm sensing unit installation step that installs a first sensor and a second sensor to the polearm neck and the polearm end separately, wherein each of the first sensor and the second sensor individually comprises a communication module, a control unit, a posture sensing unit, a microphone, and a battery unit; a polearm motion posture signal collection step that collects sensor signals of the angular acceleration, acceleration or/and geomagnetic field intensity of the change of the polearm neck's position and the change of the polearm end's position respectively through the first sensor and the second sensor respectively, and then outputs the sensor signals to the outside; a polearm motion posture signal conversion step that uses a computer equipment to receive signals of the angular acceleration, acceleration, or/and the geomagnetic field intensity transmitted by the first sensor and the second sensor individually, wherein a first computation and conversion unit of the central processing unit of the computer equipment then converts the signals into a posture angle signal of the polearm neck and a posture angle signal of the polearm end respectively; a polearm posture output step that uses a second computation and conversion unit of the central processing unit of the computer equipment to convert the posture angle signal of the polearm neck and the posture angle signal of the polearm end into parameters of the position coordinate (X₁,Y₁, Z₁) of the position of the polearm neck and the position coordinate (X₂,Y₂, Z₂) of the position of the polearm end respectively in order to obtain the motion posture at a specific time or/and the overall motion trajectory of the martial arts polearm to be output in dynamic audiovisual form.

Furthermore, the present invention may further comprise a cloud server, connected with the computer equipment through communication connection using internet, that serves as an AI data center to store motion data of the martial arts polearm practice, and to perform analysis and intelligent comparison by the smart sports module.

### BRIEF DESCRIPTION OF THE DRAWINGS

The present invention will become more fully understood from the detailed description given herein below for illustration only which thus does not limit the present invention, wherein:

FIG. 1: The schematic diagram of an embodiment and a trainee practicing the martial arts polearm device of the present invention;

FIG. 2: The structure diagram of the martial arts polearm device and the practice and training system thereof of the present invention;

FIG. 3: The schematic diagram of two position coordinate systems of the martial arts polearm device of the present invention;

FIG. 4: The schematic diagram of the first computation and conversion unit of the computer equipment of the present invention;

FIG. 5: The schematic diagram of the second computation and conversion unit of the computer equipment of the present invention;

FIG. 6: The schematic diagram of the motion posture and the overall motion trajectory of the martial arts polearm of the present invention;

FIG. 7: The schematic diagram of an embodiment of the output unit of the computer equipment of the present invention;

FIG. 8: The flowchart diagram of the posture sensing method of the martial arts polearm posture sensing device of the present invention.

### DETAILED DESCRIPTION OF THE PREFERRED EMBODIMENT

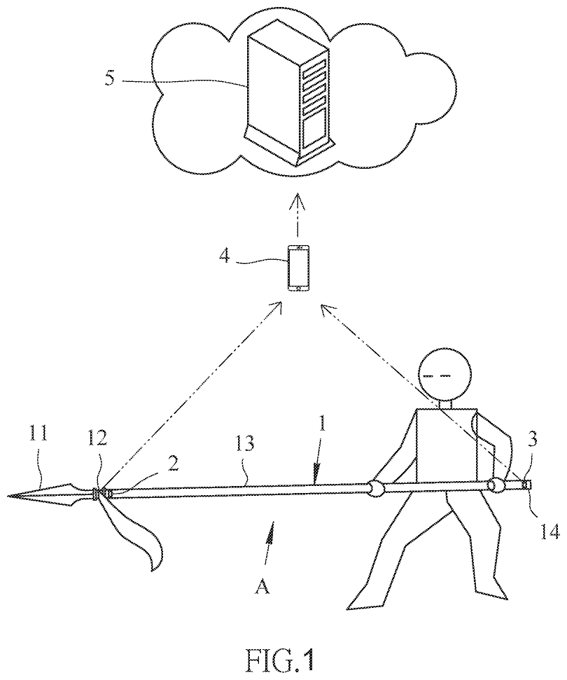

Please refer to FIG. 1. The present invention relates to a martial arts polearm posture sensing device and posture sensing method thereof which mainly has a first sensor 2 and a second sensor 3 installed on the polearm neck 12 and the polearm end 14 of the martial arts polearm 1 respectively; collects and analyzes the sensor signals of the first sensor 2 and the second sensor 3 individually through the computer equipment 4, such as smart phone APP, tablet PC or personal computer to provide the user with instant feedback; then transmits relevant data back to the AI data center in a cloud server 5 for storage; and performs analysis and intelligent comparison by the smart sports module setup in the cloud server 5 in order to assist trainees to practice and learn the postures of martial arts polearm 1. Thus, the present invention makes the exercise and training easier for the trainees while discovering the most suitable techniques and moves of the martial arts polearm, thus to increase user loyalty.

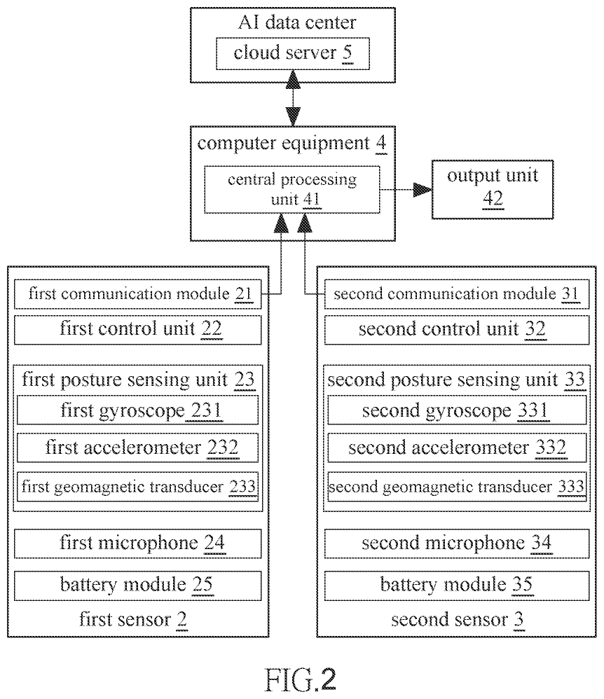

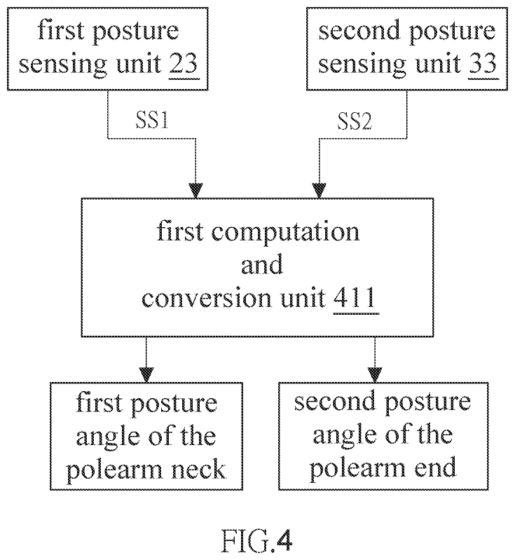

Please refer to FIG. 2 to FIG. 4. The first sensor 2 installed on the polearm neck 12 of the martial arts polearm 1 of the martial arts polearm posture sensing device A of the present invention comprises a first communication module 21, a first control unit 22, a first posture sensing unit 23, a first microphone 24, and a battery module 25, wherein the first posture sensing unit 23 further comprises a first gyroscope 231, a first accelerometer 232, a first geomagnetic transducer 233 or other combinations thereof. The first sensor 2 outputs the first sensing signal SS1 of the angular acceleration, acceleration, or/and the geomagnetic field intensity of the displacement of the polearm neck 12's position E.

With the same token, the second sensor 3 installed on the polearm end 14 of the martial arts polearm 1 of the martial arts polearm posture sensing device A of the present invention comprises a second communication module 31, a second control unit 32, a second posture sensing unit 33, a second microphone 34, and a battery module 35, wherein the second posture sensing unit 33 further comprises a second gyroscope 331, a second accelerometer 332, a second geomagnetic transducer 333 or other combinations thereof. The second sensor 3 outputs the second sensing signal SS2 of the angular acceleration, acceleration, or/and the geomagnetic field intensity of the displacement of the polearm end 14's position F.

It is worth indicating that the aforementioned first gyroscope 231, the second gyroscope 331, the first accelerometer 232, the second accelerometer 332, the first geomagnetic transducer 233, and the second geomagnetic transducer 333 are all sensing devices in triaxial form; when it is necessary, the first sensor 2 and the second sensor 3 may be further installed with a filter unit respectively to filter the noise of inertial components (such as the aforementioned gyroscopes, accelerometers, geomagnetic transducers or other combinations thereof) and errors in the output signal caused by the influence of other external environments.

Please refer to FIG. 1 and FIG. 2. One design of the computer equipment 4 is coupled to the first sensor 2 and the second sensor 3 respectively; the computer equipment 4 is electrically connected via wire or coupled via wireless to the first sensor 2 and the second sensor 3 respectively. In other words, the computer equipment 4 can be the smart phone APP, tablet PC, or personal computer. The computer equipment 4 further comprises a central processing unit 41 and an output unit 42, wherein the central processing unit 41 receives sensor signals from the first sensor 2 and the second sensor 3 to compute and convert the data into the motion posture at a specific time or/and the overall motion trajectory of the martial arts polearm 1 by a first computation and conversion unit 411 and a second computation and conversion unit 412 set in its design respectively to be output to the output unit 42.

Another embodiment of the present invention may further comprise a cloud server 5 that is connected with the computer equipment through communication connection using internet and stores the motion data (that is the motion trajectories) of the martial arts polearm 1, so that the cloud server 5 can serve as an AI data center and perform analysis and intelligent comparison through the smart sports module set therewithin to assist trainees and instructors to learn or/and teach the postures of martial arts polearm 1 while discovering the most suitable techniques and moves of the martial arts polearm.

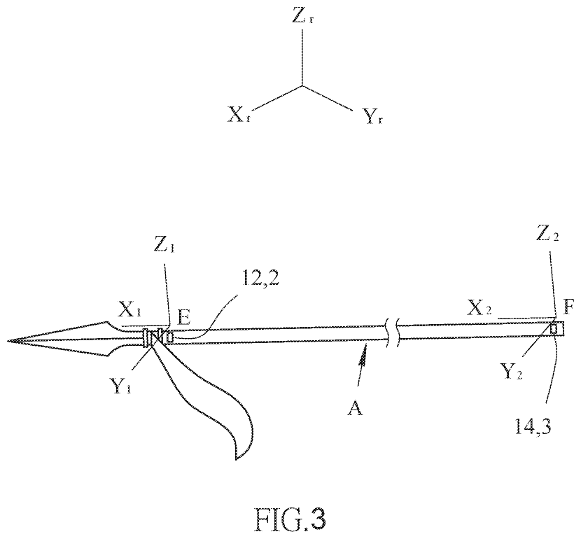

Please further refer to FIG. 2 and FIG. 3. Due to the fact that the first sensor 2 and the second sensor 3 of the martial arts polearm 1 are identical sensing devices, therefore the first sensor 2 and the second sensor 3 use the identical body coordinate system, wherein axes Xr, Yr, Zr are set as the external reference coordinate system, wherein the main function the posture angle (also known as the Euler angle) is to obtain the relative angles or rotation correlations of the body coordinate systems of the first sensor 2 and the second sensor 3 with respect to the reference coordinate systems respectively.

Furthermore, the posture angle of an object comprises a roll angle ϕ, a pitch angle θ, and a yaw angle ψ, wherein the roll angle ϕ represents a rotation angle of the sensor around the X-axis that can be obtained from the displacement of the sensor by one integration after the change of the angular velocity in X-axis; in other embodiments, the roll angle ϕ can be the rotation angle of the sensor along the X-axis that can be derived from the change of gravitational component measured by the accelerometer in triaxial form when the displacement of the sensor occurs.

The pitch angle θ represents a rotation angle of the sensor around the Y-axis that can be obtained from the displacement of the sensor by one integration after the change of the angular velocity in Y-axis; in other embodiments, the pitch angle θ can be the rotation angle of the sensor along the Y-axis that can be derived from the change of gravitational component measured by the accelerometer in triaxial form when the displacement of the sensor occurs.

Furthermore, the yaw angle iv represents a rotation angle of the sensor around the Z-axis that can be obtained from the displacement of the sensor by one integration after the change of the angular velocity in Z-axis; in other embodiments, the yaw angle iv can be the rotation angle of the sensor along the Z-axis that can be derived from the change of gravitational component measured by the accelerometer in triaxial form when the displacement of the sensor occurs.

Therefore, based on the aforementioned roll angle ϕ, the pitch angle θ, and the yaw angle ψ, the first posture sensing unit 23 of the first sensor 2 and the second posture sensing unit 33 of the second sensor 3 can provide signals of the angular acceleration, acceleration, geomagnetic field intensity, or the geomagnetic azimuth, or the combinations thereof, during the displacement of the martial arts polearm, to derive the posture angles of the polearm neck 12 and the polearm end 14 of the martial arts polearm 1 respectively.

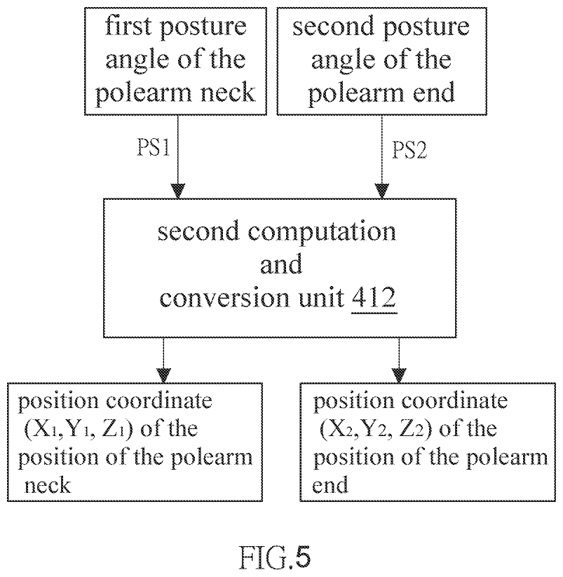

Furthermore, as shown in FIG. 2 to FIG. 5, the first computation and conversion unit 411 can produce a first posture angle (that is the first posture signal PS1) of the movement of the polearm neck 12 of the martial arts polearm 1 derived from the first sensing signal SS1 of the angular acceleration, acceleration, geomagnetic azimuth, or the combinations thereof, generated by the a first gyroscope 231, the first accelerometer 232, the first geomagnetic transducer 233 or other combinations thereof in triaxial form set in the first posture sensing unit 23, when the displacement from the first position to the second position of the polearm neck 12's position E occurs; for the same reason, the second computation and conversion unit 412 can produce a first posture angle (that is the second posture signal PS2) of the movement of the polearm end 14 of the martial arts polearm 1 derived from the second sensing signal SS2 of the angular acceleration, acceleration, geomagnetic azimuth, or the combinations thereof, generated by the second gyroscope 331, the second accelerometer 332, the second geomagnetic transducer 333 or other combinations thereof in triaxial form set in the second posture sensing unit 33, when the displacement from the third position to the fourth position of the polearm end 14's position F occurs.

The second computation and conversion unit 412 receives the first posture signal PS1 and the second posture signal PS2 output by the first computation and conversion unit 411, and performs conversion of the position coordinate through a conversion matrix C(t), wherein the conversion matrix C(t) is described below:

$$C ( t ) = [ \begin{matrix}1 & 0 & 0 \\ 0 & cos ϕ ( t ) & - sin ϕ ( t ) \\ 0 & sin ϕ ( t ) & cos ϕ ( t )\end{matrix} ] [ \begin{matrix}cos θ ( t ) & 0 & sin θ ( t ) \\ 0 & 1 & 0 \\ - sin θ ( t ) & 0 & cos θ ( t )\end{matrix} ] [ \begin{matrix}cos ψ ( t ) & - sin ψ ( t ) & 0 \\ sin ψ ( t ) & cos ψ ( t ) & 0 \\ 0 & 0 & 1\end{matrix} ] \qquad [ Mathematical Equation 1 ]$$

The first computation and conversion unit 411 can produce changes of the posture angle in the three dimensional space at a specific time through the first posture sensing unit 23 of the first sensor 2, when the displacement from the first position to the second position of the polearm neck 12 occurs; the change of the posture angle is used to obtain the conversion matrix C at a specific time. Therefore, the second computation and conversion unit 412 can multiply the conversion matrix C with the first position vector V1 of the first sensor 2 at the first position in order to derive the second position vector V2 of the first sensor 2 at the second position, so that the coordinate (X₁,Y₁,Z₁) of the second position can be obtained. The computation equation is expressed as:

V2=C(t)×V1 [Mathematical Equation 2]

Similarly, the first computation and conversion unit 411 can produce changes of the posture angle in the three dimensional space at a specific time through the second posture sensing unit 33 of the second sensor 3, when the displacement from the third position to the fourth position of the polearm end 14 occurs; the change of the posture angle is used to obtain the conversion matrix C at a specific time. Therefore, the second computation and conversion unit 412 can multiply the conversion matrix C with the third position vector V3 of the second sensor 3 at the third position in order to derive the fourth position vector V4 of the second sensor 3 at the fourth position, so that the coordinate (X₂,Y₂,Z₂) of the fourth position can be obtained. The computation equation is expressed as:

V4=C(t)×V3 [Mathematical Equation 3]

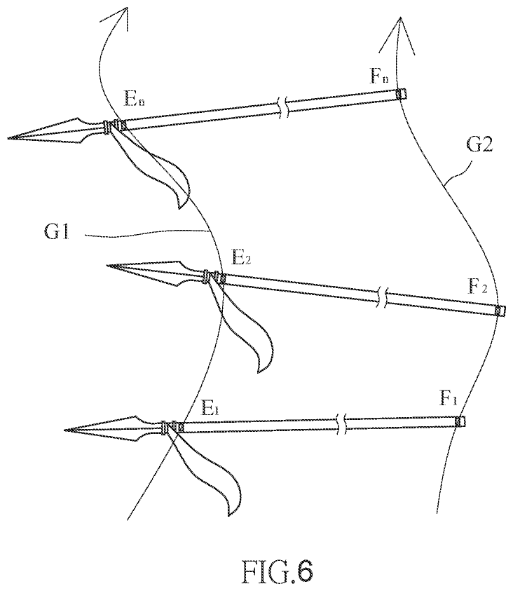

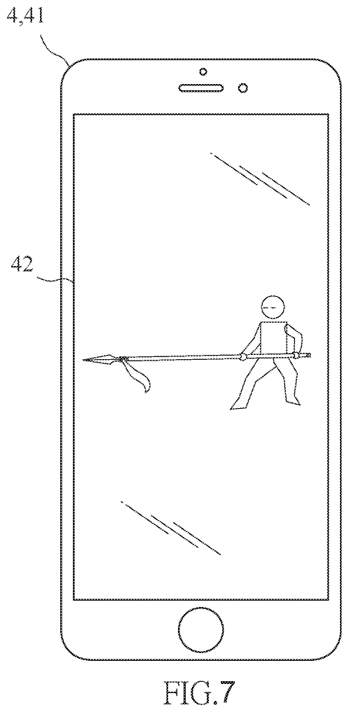

Please refer to FIG. 2 to FIG. 6. The present invention uses the first sensor 2 and the second sensor 3 installed on the polearm neck 12 and the polearm end 14 of the martial arts polearm 1 respectively in order to output the first sensing signal SS1 of the angular acceleration, acceleration, or/and geomagnetic field intensity, generated by the gyroscope, the accelerometer, the geomagnetic transducer set in the posture sensing unit, when the displacement of the polearm neck 12's position E occurs; and the second sensing signal SS2 of the angular acceleration, acceleration, or/and geomagnetic field intensity, generated by the gyroscope, the accelerometer, the geomagnetic transducer set in the posture sensing unit, when the displacement of the polearm end 14's position F occurs, to the outside. Next, the first computation and conversion unit 411 separately computes the first posture angle (that is the first posture signal PS1) of the movement of the polearm neck 12 of the martial arts polearm 1 derived from the first sensing signal SS1, and the second posture angle (that is the second posture signal PS2) of the movement of the polearm end 14 of the martial arts polearm 1 derived from the second sensing signal SS2. Last, the second computation and conversion unit 412 separately computes the position coordinate (X₁,Y₁,Z₁) of the position E of the polearm neck 12 of the martial arts polearm 1 and the position coordinate (X₂,Y₂,Z₂) of the position F of the polearm end 14 of the martial arts polearm based on the first posture signal PS1 and the second posture signal PS2 respectively, so that the overall posture of the martial arts polearm 1 is defined based on the position coordinate (X₁,Y₁,Z₁) and the position coordinate (X₂,Y₂,Z₂) and stored in the computer equipment 4. As shown in FIG. 6, by applying multiple position coordinates of E1, E2 . . . En and the corresponding multiple position coordinates of F1, F2 . . . Fn, the motion trajectory G1 of the polearm neck 12 of the martial arts polearm 1 and the corresponding motion trajectory G2 of the polearm end 14 of the martial arts polearm 1 can be obtained respectively, so that the overall posture of the martial arts polearm 1 is produced and stored in the computer equipment 4 or uploaded to the cloud server 5 for storage. As shown in FIG. 6 and FIG. 7, the overall posture, output to the output unit 42 in a graphical display form, let trainees view and improve their techniques and moves of the martial arts polearm, or the overall postures undergo the analysis and intelligent comparison by the smart sports module setup in the cloud server 5 in order to assist trainees and instructors to learn or teach the martial arts polearm respectively while discovering the most suitable techniques and moves of the martial arts polearm.

For another embodiment of the present invention, please refer to FIG. 2, FIG. 6 and FIG. 7. The first sensor 2 and the second sensor 3 also can be installed with a first microphone 24 and a second microphone 34 respectively in order to synchronously collect sound generated from motion of the martial marts polearm 1, for example sound created by the moves of pushing aside or blocking away the attack, whooshing wind sound, etc., in conjunction with the motion trajectory G1 of the polearm neck 12's position E of the martial arts polearm 1 and the motion trajectory G2 of the polearm end 14's position F of the martial arts polearm 1, so that the overall motion trajectory of the martial arts polearm 1 is output to the output unit 42 in audiovisual form to help trainees discover the most suitable techniques and moves of the martial arts polearm.

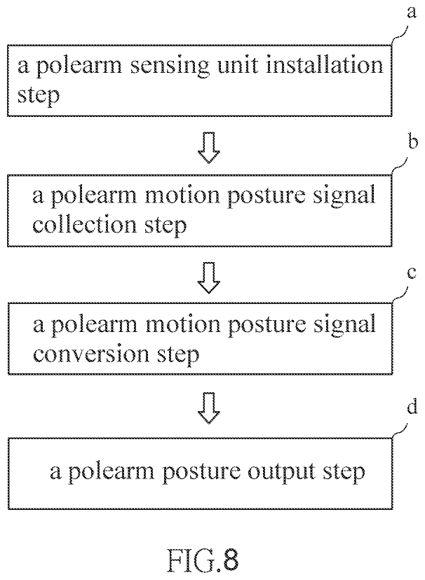

In summary, as shown in FIG. 8, the martial arts polearm posture sensing method of the present invention comprises the steps of: a polearm sensing unit installation step a that installs a first sensor and a second sensor to the polearm neck and the polearm end separately, wherein each of the first sensor and the second sensor individually comprises a communication module, a control unit, a posture sensing unit, a microphone, and a battery unit; a polearm motion posture signal collection step b that collects sensor signals of the angular acceleration, acceleration or/and geomagnetic field intensity of the change of the polearm neck's position and the change of the polearm end's position respectively through the first sensor and the second sensor respectively, and then outputs the sensor signals to the outside; a polearm motion posture signal conversion step c that uses a computer equipment to receive signals of the angular acceleration, acceleration, or/and the geomagnetic field intensity transmitted by the first sensor and the second sensor individually, wherein a first computation and conversion unit of the central processing unit of the computer equipment then converts the signals into a posture angle signal of the polearm neck and a posture angle signal of the polearm end respectively; a polearm posture output step d that uses a second computation and conversion unit of the central processing unit of the computer equipment to convert the posture angle signal of the polearm neck and the posture angle signal of the polearm end into parameters of the position coordinate (X₁,Y₁,Z₁) of the position of the polearm neck and the position coordinate (X₂,Y₂,Z₂) of the position of the polearm end respectively in order to obtain the motion posture at a specific time or/and the overall motion trajectory of the martial arts polearm to be output in dynamic audiovisual form.

What is claimed is:

1. A martial arts polearm posture sensing device, comprising:
a first sensor, installed on the polearm neck, which comprises a first communication module, a first control unit, a first posture sensing unit, and a battery unit, wherein the first posture sensing unit outputs signals of the angular acceleration, acceleration, or/and the geomagnetic field intensity of the change of the polearm neck's position;
a second sensor, installed on the polearm end, which comprises a second communication module, a second control unit, a second posture sensing unit, and a battery unit, wherein the second posture sensing unit outputs signals of the angular acceleration, acceleration, or/and the geomagnetic field intensity of the change of the polearm end's position; and
a computer equipment, coupled to the first sensor and the second sensor respectively, which further comprises a central processing unit and an output unit, wherein the central processing unit receives sensor signals from the first sensor and the second sensor to compute and convert the data into the motion posture at a specific time or/and the overall motion trajectory of the martial arts polearm to be output to the output unit.

2. The martial arts polearm posture sensing device as claimed in claim 1, wherein the computer equipment is electrically connected via wire or coupled via wireless to the first sensor and the second sensor respectively.

3. The martial arts polearm posture sensing device as claimed in claim 1, wherein the first posture sensing unit comprises a first gyroscope, a first accelerometer or/and a first geomagnetic transducer in triaxial form; the second posture sensing unit comprises a second gyroscope, a second accelerometer or/and a second geomagnetic transducer in triaxial form.

4. The martial arts polearm posture sensing device as claimed in claim 1, wherein the central processing unit further comprises a first computation and conversion unit; the first computation and conversion unit converts the signals from the first sensor and the second sensor into a first posture angle signal of the position of the polearm neck and a second posture angle signal of the position of the polearm end respectively.

5. The martial arts polearm posture sensing device as claimed in claim 4, wherein the central processing unit further comprises a second computation and conversion unit; the second computation and conversion unit converts the first posture angle signal and the second posture angle signal into parameters of the position coordinate (X₁,Y₁,Z₁) of the position of the polearm neck and the position coordinate (X₂,Y₂,Z₂) of the position of the polearm end respectively.

6. The martial arts polearm posture sensing device as claimed in claim 1, wherein the first sensor and the second sensor also are installed with a first microphone and a second microphone respectively in order to synchronously collect sound generated from motion of the martial marts polearm to be output to the output unit in audiovisual form.

7. The martial arts polearm posture sensing device as claimed in claim 1, wherein the martial arts polearm sensing device further comprises a cloud server that is connected with the computer equipment through communication connection using internet and stores the motion data of the martial arts polearm, so that the cloud server can serve as an AI data center.

8. A martial arts polearm posture sensing method, comprising:
a polearm sensing unit installation step that installs a first sensor and a second sensor to the polearm neck and the polearm end separately, wherein each of the first sensor and the second sensor individually comprises a communication module, a control unit, a posture sensing unit, a microphone, and a battery unit;
a polearm motion posture signal collection step that collects sensor signals of the angular acceleration, acceleration or/and geomagnetic field intensity of the change of the polearm neck's position and the change of the polearm end's position respectively through the first sensor and the second sensor respectively, and then outputs the sensor signals to the outside;
a polearm motion posture signal conversion step that uses a computer equipment to receive signals of the angular acceleration, acceleration, or/and the geomagnetic field intensity transmitted by the first sensor and the second sensor individually, wherein a first computation and conversion unit of the central processing unit of the computer equipment then converts the signals into a posture angle signal of the polearm neck and a posture angle signal of the polearm end respectively; and
a polearm posture output step that uses a second computation and conversion unit of the central processing unit of the computer equipment to convert the posture angle signal of the polearm neck and the posture angle signal of the polearm end into parameters of the position coordinate (X₁,Y₁, Z₁) of the position of the polearm neck and the position coordinate (X₂,Y₂, Z₂) of the position of the polearm end respectively in order to obtain the motion posture at a specific time or/and the overall motion trajectory of the martial arts polearm to be output in dynamic audiovisual form.
